(19) United States
(12) Patent Application Publication
(10) Pub. No.: US 2006/0033959 A1
(43) Pub. Date: Feb. 16, 2006

(54) Systems and methods for trapping in a publishing environment

(75) Inventor: David C. Allen, Denver, CO (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: Quark, Inc., Denver, CO (US)

(21) Appl. No.: 11/196,613

(22) Filed: Aug. 2, 2005

Related U.S. Application Data
(63) Continuation-in-part of application No. 10/710,944, filed on Aug. 13, 2004.

(51) Int. Cl. H04N 1/409

(52) U.S. Cl. 358/3.26

(57) ABSTRACT

Various systems and methods for trapping in a publishing environment are disclosed. For example, a method for trapping in a printing process is disclosed and includes identifying two objects associated with the trap. One of the objects is a foreground object, and the other is a background object. A trap zone is created around at least one of the foreground and background objects, and a trap direction is determined based at least in part on an ink characteristic of an ink associated with a color of the background and/or foreground. The trap direction may include a choke, an overprinting, a spread, and/or a knockout.

### CROSS REFERENCE TO RELATED APPLICATIONS

The present application is a continuation in part of U.S. patent application Ser. No. 10/710,944 entitled “Automated Trapping System for Desktop Publishing”, and filed Aug. 13, 2004 by Allen. The aforementioned application is assigned to an entity common hereto, and the entirety of the application is incorporated herein by reference for all purposes.

### BACKGROUND OF THE INVENTION

The present invention relates to systems and methods for production of publications, and in particular to systems and methods for printing multi-color publications.

Electronic printing of multi-color pages typically involves printing on multiple separations to provide high quality publications. This process can involve four process colors (e.g., Cyan, Magenta, Yellow, Black) plus additional spot colors as needed (e.g., Red, Green, Blue). Applying each of the process colors involves an individual film separation or printing plate, and application of the spot colors involves an additional separation or printing plate for each additional color used.

Misregistration of the separations often causes a slight shift in the placement of the various colors. Because printing inks are often not completely opaque, printing one ink over another can result in a third color occuring at the intersection. This is desirable where the third color is intended, but undesirable where a crisp line between the colors is desired. Another problem occurs when a white space is left between printed inks. Compensating for the misregistrations is often referred to as trapping, and can involve the application of one or more rules to assure that neither white space nor unintended third colors are formed in the printing process. Typical trapping, however, is limited in its ability and often do not operate properly where a printed object utilizes unique colors having gray values and rich black values.

Hence, for at least the aforementioned reasons, there exists a need in the art for advanced systems and methods to address the needs of the industry.

### BRIEF SUMMARY OF THE INVENTION

The present invention relates to systems and methods for production of publications, and in particular to systems and methods for printing multi-color publications.

Some embodiments of the present invention provide systems and methods for trapping in a publishing environment. For example, a method for trapping in a printing process is disclosed and includes identifying two objects associated with the trap. One of the objects is a foreground object, and the other is a background object. A trap zone is created around at least one of the foreground and background objects, and a trap direction is determined based at least in part on an ink characteristic of an ink associated with a color of the background and/or foreground. The trap direction may include a choke, an overprinting, a spread, and/or a knockout.

Various embodiments of the present invention provide methods for trapping misregistration of a printing separation. Such methods include identifying two colors associated with a trap. In addition, an ink characteristic associated with one of the colors, and an ink characteristic associated with the other color are determined. Based at least in part on either or both of the determined ink characteristic, a direction of the trap is determined. In some instances, the direction of the trap is a spread, a choke, a knockout, or an overprint. Further, determining the ink characteristics may include one or more of the following: evaluating a total luminance for a color based on one or more inks used in creating the color; evaluating a total gray for a color based on one or more inks used in creating the color; evaluating a partial gray for a color based on one or more inks used in creating the color, and/or evaluating a principle gray for a color based on one or more inks used in creating the color.

In one particular case, determining the first ink characteristic includes evaluating a partial gray value associated with one ink. In such a case, determining the direction of the trap may include comparing the partial gray value of the ink with a partial gray value threshold. Where the partial gray value of the ink exceeds the partial gray threshold, the direction of the trap is a knockout. In another case, one of the colors is a foreground color and the other color is a background color. A luminance of the foreground color and a luminance of the background color are determined based at least in part on one or more constituent inks of the respective colors. In such a case, the direction of the trap is spread where the luminance of the foreground color is greater than the luminance of the background color, and a choke where the luminance of the foreground color is less than the luminance of the background color.

In one or more cases, of two or more inks used to form a given color are determined. In such cases, the direction of the trap may be determined based on a comparison of the ink characteristic of the inks used to form the given color. In one particular case where the partial gray value of one of the constituent inks is less than a partial gray value threshold and less than a rich black threshold, and a partial gray value of one of the other constituent inks is greater than the rich black threshold, the direction of the trap is an overprint for the color.

Other embodiments of the present invention provide methods for correcting defects in a printing process. The methods include identifying a foreground object and a background object, and creating a trap zone around at least the foreground object. The methods further include determining a trap direction based at least in part on an ink characteristic of one or more inks associated with either or both of a color of the foreground object and a color of the background object.

Yet other embodiments of the present invention provide software that is executable to perform one or more functions consistent with the aforementioned methods. The software may be formed onto various media that may be accessible via a computer such as, for example, a hard disk drive, an optical media, a compact disk, a floppy diskette, a tape drive, a random access memory, and/or the like. Further, the software may be executed by microprocessor based systems, digital signal processor based systems, or other instruction based systems. Some embodiments of the present invention provide computer readable media with instructions executable to identify a foreground and a background object; create a trap zone associated with at least the foreground object; and to determine a trap direction based at least in part on an ink characteristic of at least one of a color of the first object and a color of the second object.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a flow diagram for calculating varioius parameters in accordance with one or more embodiments of the present invention;

FIG. 2 is a flow diagram for determining trap direction in accordacne with various embodiments of the present invention;

FIG. 3 are a series of process diagrams using an exemplary design to show the operation of one or more methods of the present invention;

FIG. 4 show a plate by plate deposition process to implement the exemplary design in accordance with various embodiments of the present invention; and

FIG. 5 show a plate by plate deposition process to implement the exemplary design in accordance with other embodiments of the present invention.

### DETAILED DESCRIPTION OF THE INVENTION

The present invention relates to systems and methods for production of publications, and in particular to systems and methods for printing multi-color publications.

Some embodiments of the present invention provide systems and methods for trapping in a publishing environment. For example, a method for trapping in a printing process is disclosed that includes identifying two objects associated with the trap. One of the objects is a foreground object, and the other is a background object. As used herein, the term “foreground object” is used in its broadest sense to mean any object that is displayed as if it is atop another object and/or appears as if it may have been printed atop another object. Thus, for example, a foreground object may be a text, a line, a frame, a box, or any other graphical object that is displayed, printed and/or appears atop another object. As yet a further concrete example, a foreground object may be a line surrounded or atop a background color. As used herein, the term “background object is used in its broadest sense to mean any object that is displayed as if it is under another object and/or appears as if it may have been printed under another object. Thus, for example, a background object may be a text, a line, a frame, a box, or any other graphical object that is displayed, printed and/or appears to be overlapped by another object. As a more particular example, a background object may be a color surrounding a foreground text.

The method further includes creating a trap zone around at least one of the foreground and background objects, and a trap direction is determined based at least in part on an ink characteristic of an ink associated with a color of the background and/or foreground. As used herein, the term “trap zone” is used in its broadest sense to mean any area of potential intersection of foreground and background objects. The trap direction may include a choke, an overprinting, a spread, and/or a knockout. As used herein, the term “choke” is used in its broadest sense to mean any process whereby a background object is augmented at its edges such that it overlaps the edges of a corresponding foreground object. Thus, for example, a choke occurs where an ink associated with a background object encroaches the intersection between the foreground and background objects. As used herein, the term “spread” is used in its broadest sense to mean any process whereby a foreground object is augmented at its edges such that it overlaps the edges of a corresponding background object. Thus, as an example, a spread occurs where ink associated with the foreground object encroaches the intersection between the foreground and background objects. As used herein, the term “knockout” is used in its broadest sense to mean any process whereby a portion of a background object is eliminated at an area corresponding to a foreground object. Thus, as an example, a knockout may occur where a background object forms an aperture that is void of any ink in an area corresponding to a related foreground object. As used herein, the term “overprinting” is used in its broadest sense to mean any process whereby a background object is printed in its entirety, and the corresponding foreground object is printed over the background object.

Colors used to paint objects may be comprised of one or more component inks. As one example, a color may be formed using a CMYK four color separation process. In such a case, the color used to paint the object may include constituent amounts of Cyan, Magenta, Yellow and Black inks. This may be further augmented by spot colors. Some embodiments of the present invention provide for trapping on an ink by ink basis, rather than on simply an overall object basis. In such embodiments, various ink characteristics may be determined including, but not limited to, evaluating a partial luminance for a color based on one or more inks used in creating the color, and therefrom evaluating a total luminance for the color. Other examples include evaluating a total gray for a color based on one or more inks used in creating the color; evaluating a partial gray for a color based on one or more inks used in creating the color, and/or evaluating a principle gray for a color based on one or more inks used in creating the color. Based on the disclosure provided herein, one of ordinary skill in the art will recognize other ink characteristics that may be used in relation to one or more embodiments of the present invention.

As used herein, the term “partial luminance” is used in its broadest sense to mean any value representing the lightness of a color formed with less than all constituent inks of an overall color. Thus, for example, where an overall color is formed using a CMYK process, a partial luminance may be a value representing the lightness of the Cyan component of the overall color. This may be determined, for example, by assessing the RGB value of a given ink using a formula. In one particular case, the formula is: Partial Luminance=(Red*0.3)+(Green*0.59)+(Blue*0.11). As used herein, the term “total luminance” is used in its broadest sense to mean the sum of one or more partial luminance values for an overall color. Thus, for example, where an overall color is formed using a CMYK process, the total luminance for the overall color may be the sum of the partial luminance for the Cyan component, the partial luminance of the Magenta component, the partial luminance of the Yellow component, and the partial luminance of the Black component.

As used herein, the term “gray value” is used in its broadest sense to mean any color value where all three constituent components (i.e., RGB) are equal. In some cases, gray value may be referred to herein as pixel intensity. As used herein, the term “partial gray” value is used in its broadest sense to be any value representing the gray value of less than all constituent inks of a given overall color. Thus, as just one example, a partial gray value may be a gray value associated with a Cyan component of the overall color. This may be determined, for example, by applying a formula to a constituent ink. In one particular case, the formula is: Partial Gray=(1−Ink Partial Luminance).

As used herein, the term “total gray” is used in its broadest sense to mean any hypothetical gray value formed by summing the gray values for each of the constituent inks. The total gray value is often a hypothetical value that exceeds typical black. In a four ink process, total gray may be determined using the following formula: Total Gray=(1−Ink1 Partial Luminance)+(1−Ink2 Partial Luminance)+(1−Ink3 Partial Luminance)+(1−Ink4 Partial Luminance). Also, as used herein, the term “principle gray” is defined broadly as the total gray of an object divided by the number of constituent inks used to paint the object plus an offset. The formula is as follows: Principle Gray=Total Gray/(n+offset), where n=the number of inks. The offset value is useful in the event that two or more constituent inks have an equal gray value, and in one embodiment is set between 0.0 and 0.1.

Also, as used herein, the term “rich black” is used in its broadest sense to mean any color formed from black augmented by one or more colors. Thus, for example, a rich black may be formed primarily of black and augmented with a small amount of Cyan to form a deeper black.

One or more embodiments of the present invention may be implemented as software executable by a computer to implement the methods. Such computers may be microprocessor based such as, for example a personal computer, server, personal digital assistant, laptop computer and/or the like. Based on the disclosure provided herein, one of ordinary skill in the art will recognize other types of computers that execute instructions such as, but not limited to, digital signal processor based computers and/or the like. Further, one of ordinary skill in the art will recognize that software in accordance with the present invention may be maintained on a computer readable medium. The computer readable medium such as, for example, a hard disk drive or a random access memory may be associated with a computer executing the software instructions, or maintained separate from the computer executing the software instructions. Based on the disclosure provided herein, one of ordinary skill in the art will recognize a variety of computer readable media that may be used in accordance with one or more embodiments of the present invention.

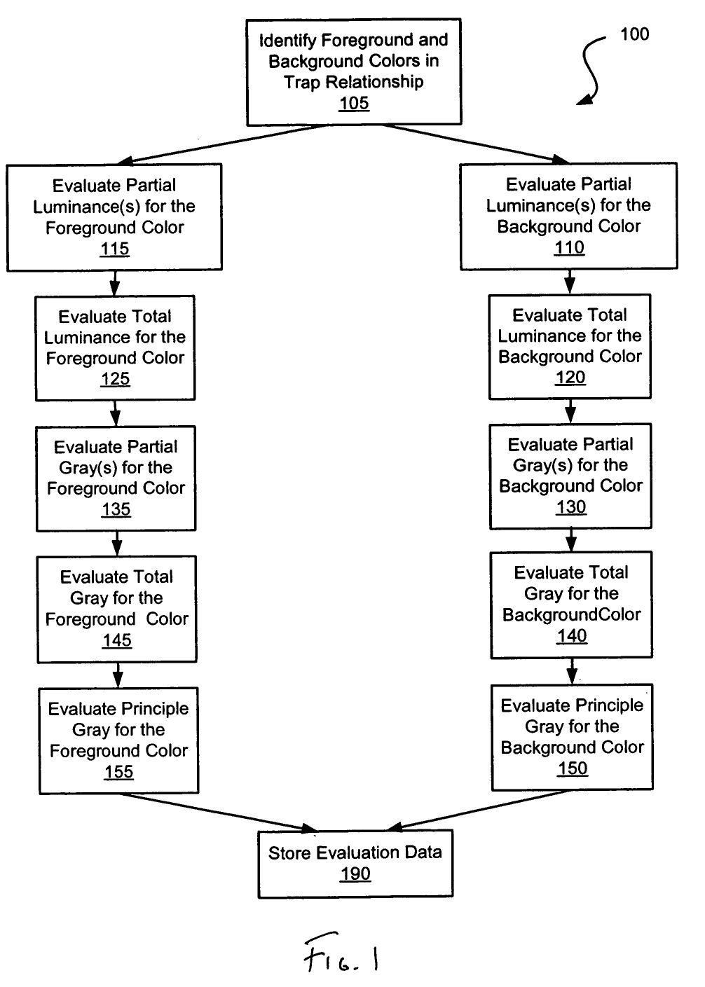

Turning to FIG. 1, a flow diagram 100 illustrates a series of evaluations performed on a foreground object and a background object in accordance with one or more embodiments of the present invention. Following flow diagram 100, a color of a background object and a color of a foreground object are identified (block 105). These identified colors are typically formed by combining two or more constituent inks in accordance with a color recipe. Thus, for example, where the colors are to be formed using a CMYK four color process, the colors may be formed of some combination of Cyan, magenta, Yellow and Black inks. Based on the disclosure provided herein, one of ordinary skill in the art will recognize a variety of color schemes and constituent inks that may be used in relation to one or more embodiments of the present invention.

A luminance value for the foreground color is evaluated (blocks 115, 125), and a luminance value of the background color is evaluated (blocks 110, 120). In one particular embodiment of the present invention, the luminance values are evaluated by calculating the partial luminance value for each of the constituent inks forming the color, and summing the calculated partial luminance values. Thus, for example, where the color is comprised of three inks: ink1, ink2 and ink3. Each of the three inks are defined using an RGB color scale, and the partial luminance for each of the three inks is calculated using the following equations:
Partial Lum_{INK1}=(Red_{INK1}*0.3)+(Green_{INK1}*0.59)+(Blue_{INK1}*0.11);
Partial Lum_{INK2}=(Red_{INK2}*0.3)+(Green_{INK2}*0.59)+(Blue_{INK2}*0.11); and
Partial Lum_{INK3}=(Red_{INK3}* 0.3)+(Green_{INK3}*0.59)+(Blue_{INK3}*0.11).
The total luminance for the color is then calculated by adding the partial luminance values associated with the individual inks in accordance with the following equation:
Total Lum=Partial Lum_{INK1}+Partial Lum_{INK2}+Partial Lum_{INK3}.

In addition, or alternatively, a gray value for the foreground color is evaluated (blocks 135, 145), and a gray value for the background color is evaluated (blocks 135, 145). In one particular embodiment of the present invention, the gray values are evaluated by calculating the partial gray value for each of the constituent inks forming the color, and summing the calculated partial gray values. Thus, using the above example of three inks, a partial gray value for each of the inks may be calculated using the following equations:
Partial Gray_{INK1}=(1−Partial Lum_{INK1});
Partial Gray_{INK2}=(1−Partial Lum_{INK2}); and
Partial Gray_{INK3}=(1−Partial Lum_{INK3}).
The total gray for the color is then calculated by adding the partial gray values associated with the individual inks in accordance with the following equation:
Total Gray=Partial Gray_{INK1}+Partial Gray_{INK2}+Partial Gray_{INK3}.

In some cases, a principle gray value of the foreground color and a principle gray value of the background color are also evaluated (blocks 150, 155). In one particular case, principle gray value for the particular color is determined using the following equation:
Principle Gray=Total Gray/(n+offset).
In the aforementioned equation, “n” is the number of constituent inks used to form the color, and offset is a value between 0.0 and 0.1 used to assure that distinct colors don't have exactly the same principal gray value. One or more of the aforementioned values are also stored (block 190). As will be appreciated by one of ordinary skill in the art, there are many ways of storing the values including, but not limited to, storing the values to a computer readable medium such as a hard disk drive or some other memory device.

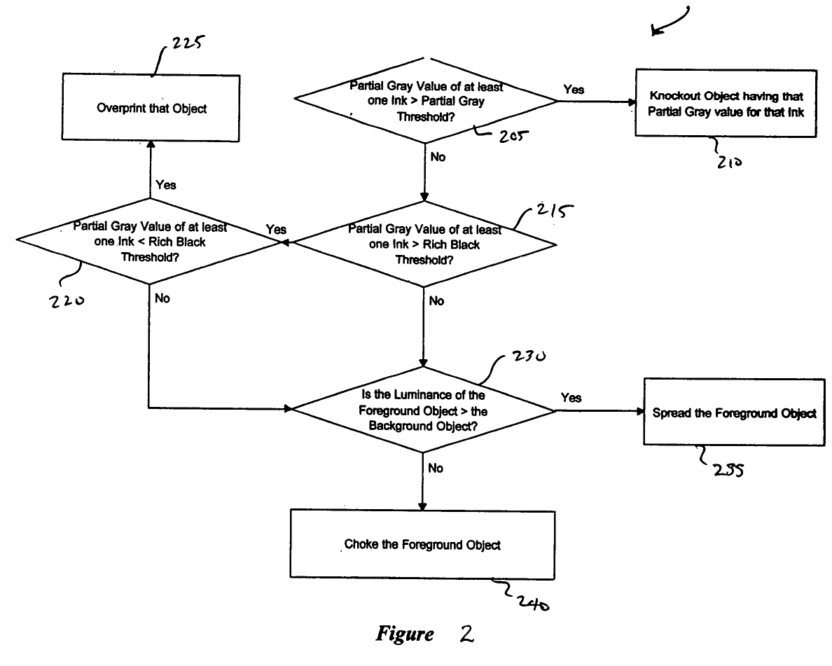

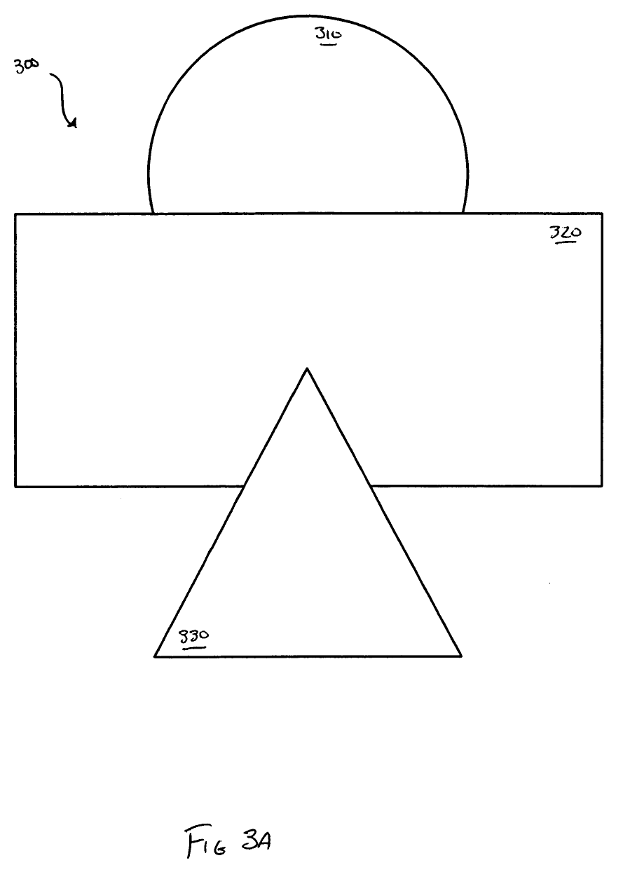

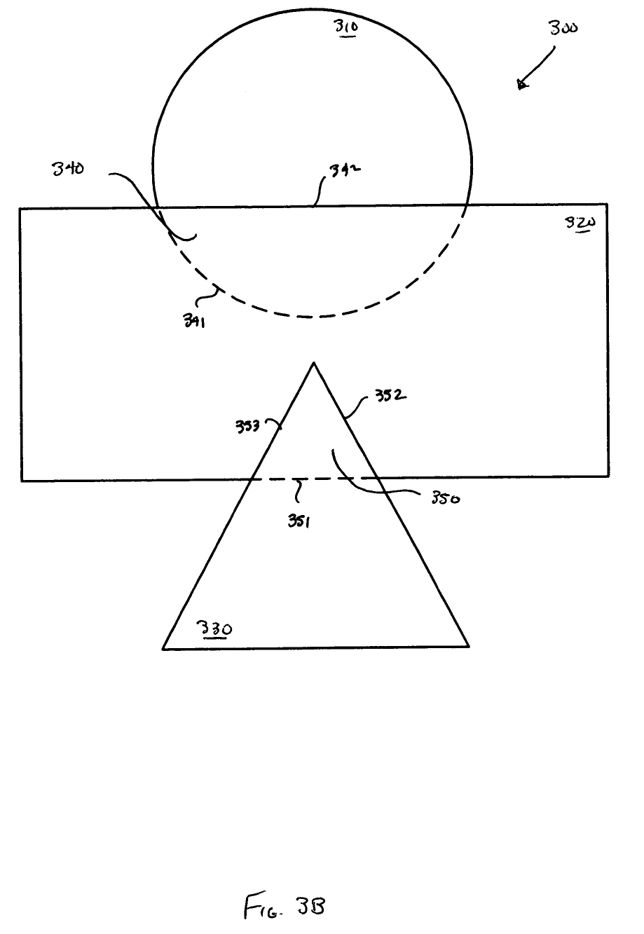

Turning to FIG. 2, a flow diagram 200 illustrates a method for trapping in accordance with one or more embodiments of the present invention. Following flow diagram 200, it is determined whether the partial gray value for any of the constituent inks used to form the background color is greater than a partial gray threshold value (block 205). The partial gray threshold value may be user programmable, and may be set at a level that will assure proper printing of the foreground object in relation to the background object. In some cases, a default partial gray threshold value is utilized where a user defined value is not provided. Where the partial gray value for any of the constituent inks is greater than the partial gray threshold value (block 205), the background object is knocked out (block 210).

Alternatively, where the partial gray value for all of the constituent inks is less than the partial gray threshold value (block 205), the background object is a candidate for overprinting (block 225). Overprinting occurs where the partial gray value for any of the constituent inks is greater than a rich black threshold (block 215), and a partial gray value of another of the constituent inks is less than the rich black threshold (block 220). The rich black threshold may be user programmable, and may be set at a level to assure proper printing of the foreground object in relation to the background object. In some cases, a default rich black threshold value is utilized where a user defined value is not provided.

In addition, it is determined if the total luminance of the foreground object is greater than the total luminance of the background object (block 230). Where the total luminance of the foreground object is greater than that of the background object (block 230), the foreground object is spread onto the background object (block 235). Alternatively, where the total luminance of the foreground object is less than that of the background object (block 230), the foreground object is choked in relation to the background object (block 240). In some cases partial luminance can be used which provides for a trap fill determination on an ink by ink basis.

In some cases, a “zero” condition is also considered where, for example, a choke or spread condition is identified based on a particular ink. In such a situation, an ink may be compared, and the trap direction based on the comparison determined to be a spread. In general, this determination would result in the location where the ink is painted being augmented or spread into the trap zone. However, where the ink is a “zero” ink (i.e., a white space or non-ink condition), an override of the determination is done and the spread is not performed. Alternatively, where the trap direction is determined to be a choke and the ink is a zero ink, an override of the determination is done and the choke is not performed. In some cases, this override condition is an exception to the general rules set forth above.

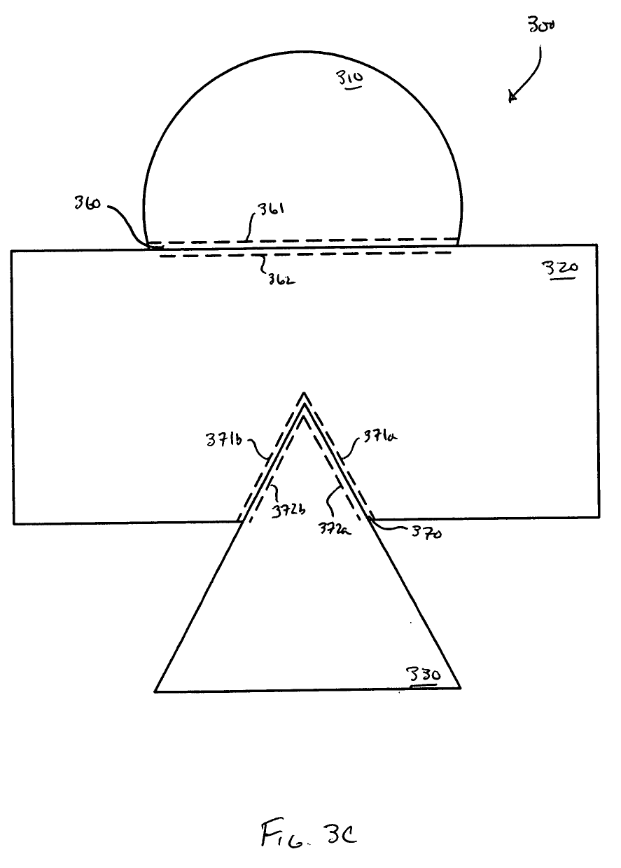

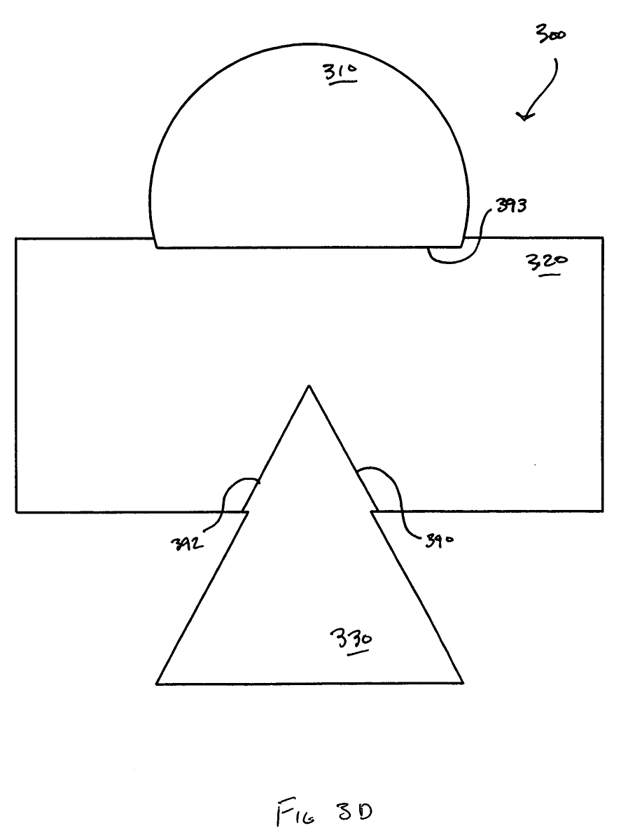

Turning to FIG. 3, an operation consistent with flow diagram 200 is shown in relation to a design 300. As shown in FIG. 3A, design 300 includes a rectangular object 320 underlying a triangular object 330 and overlying a circular object 310. FIG. 3B shows a combination of foreground and background objects defined by the intersection of rectangular object 320, triangular object 330, and circular object 310. More specifically, a portion of rectangular object 320 corresponding to an area 340 (bounded by a dashed line 341 and a portion 342 of the perimeter of rectangular object 320) is a foreground object, and a portion of circular object 310 corresponding to area 340 is a background object. Similarly, a portion of rectangular object 320 corresponding to an area 350 (bounded by a dashed line 351 and portions 351, 352 of the perimeter of triangle 330) is a background object, and a portion of triangular object 330 corresponding to area 350 is a foreground object.

One or more embodiments of the present invention include creating a trap zone around an object (foreground or background) defined at a location of intersection. FIG. 3C depicts a trap zone 360 formed in relation to the object(s) associated with the area 340 (not shown on FIG. 3C), and a trap zone 370 formed in relation to the object(s) associated with the area 350 (not shown in FIG. 3C). Trap zone 360 is defined as an area between a dashed line 361 and another dashed line 362. In some cases, the size of trap zone 360 (i.e., distance from dashed line 361 to dashed line 362) may be user defined, or a default value may be used. In such cases, a parameter may be set in a program, and when a trap zone is to be formed, it is formed to a size defined by the parameter. Based on the disclosure provided herein, one of ordinary skill in the art will appreciate a variety of methods and/or approaches that may be used to set the size of a trap zone. For example, it may be that the size of the trap zone is set automatically by importing a determined potential misregistration for a selected printing press. In such a case, a parameter controlling the size of the trap zone may be set to a value used to define the operation of the selected press.

Trap zone 370 is defined as an area between dashed line 371 and dashed line 372. Similar to trap zone 360, the size of trap zone 370 (i.e., distance between dashed line 371 and dashed line 372) may be user defined, or in other cases automatically determined. Where the size of trap zone 370 is automatically determined, it may be determined using an approach similar to that described in relation to trap zone 360.

The direction of the trap may be determined through use of a method such as that described in relation to FIG. 2. Thus, for example, where the direction of the trap associated with trap zone 360 is determined to be a choke, the ink associated with circular object 310 encroaches on rectangular object 320 up to the boundary defined by dashed line 362. Alternatively, where the direction of the trap associated with trap zone 370 is determined to be a spread, the ink associated with rectangular object 320 encroaches on circular object 310 up to the boundary defined by dashed line 361. Using another example, where the direction of the trap associated with trap zone 370 is determined to be a choke, the ink associated with rectangular object 320 encroaches on triangular object 330 up to the boundary defined by dashed line 372. In contrast, where the direction of the trap associated with trap zone 370 is determined to be a spread, the ink associated with triangular object 330 encroaches on rectangular object 320 up to the boundary defined by dashed line 371.

Turning to FIG. 3D, a printed version of design 300 is shown where the direction of the trap at the intersection of circular object 310 and rectangular object 320 is a choke. As stated above, this results in the background object (circular object 310) encroaching on the foreground object (rectangular object 320). The direction of the trap at the intersection of triangular object 330 and rectangular object 320 is a spread. As stated above, this results in the foreground object (triangular object 330) encroaching on the background object (rectangular object 320).

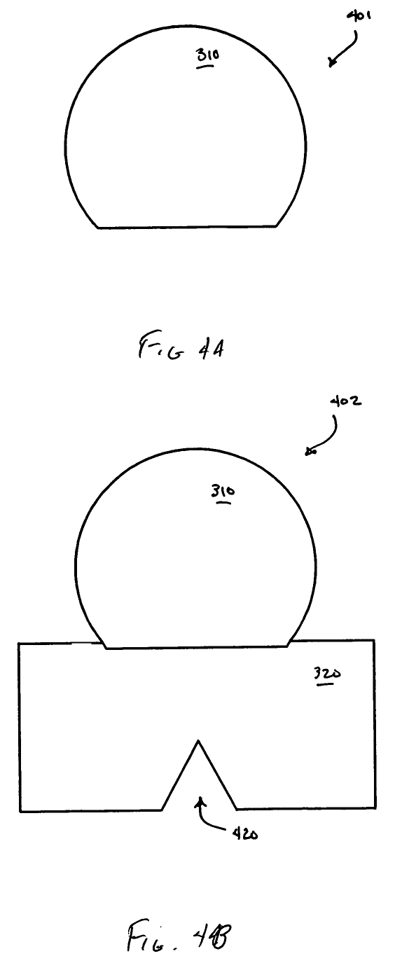

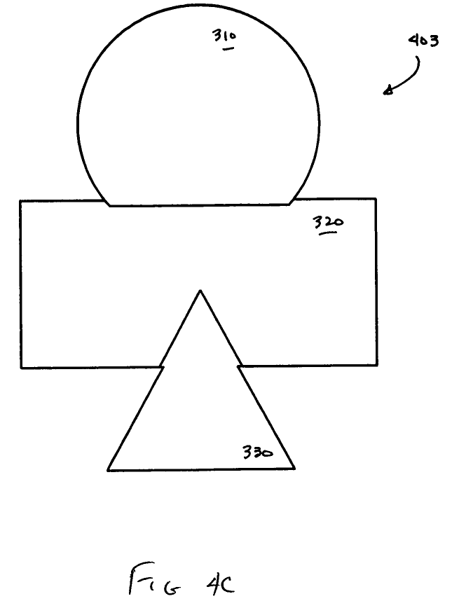

Turning to FIG. 4, a plate by plate deposition process to implement the exemplary design of FIGS. 3 is illustrated. For the purposes of this discussion, it is assumed that each of objects 310, 320, 330 are formed during a single plate process that is mutually exclusive of the single plate processes used to form the other objects. As depicted in FIG. 4A, a plate 401 is first painted that includes object 310 formed such that it encroaches in the trap zone as described in relation to FIG. 3. Next, as shown in FIG. 4B, a plate 402 is painted that includes object 320 with a knockout 420, and with object 310 encroaching thereon. Finally, as shown in FIG. 4C, a plate 403 is painted such that a portion of object 330 is formed in knockout 420.

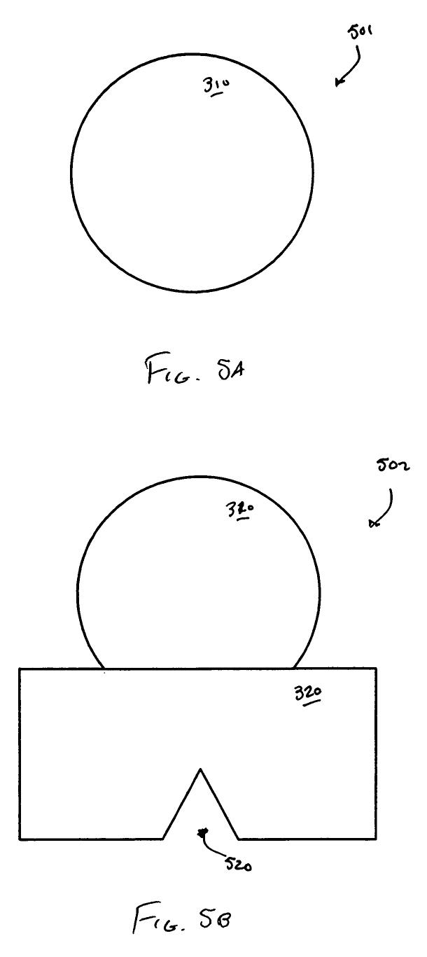

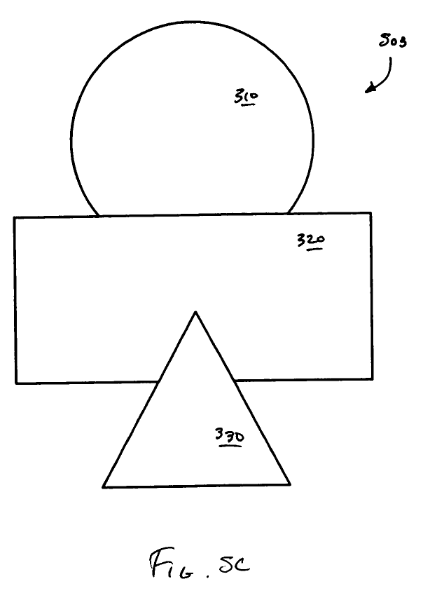

Turning to FIG. 5, another plate by plate deposition process to implement the exemplary design of FIGS. 3 is illustrated. Similar to that of FIG. 4, for the purposes of this discussion, it is assumed that each of objects 310, 320, 330 are formed during a single plate process that is mutually exclusive of the single plate processes used to form the other objects. Further, it is assumed that the trap direction was to be an overlap and a cutout. As depicted in FIG. 5A, a plate 501 is first painted that includes the entirety of object 310. Next, as shown in FIG. 5B, a plate 502 is painted that includes object 320 with a knockout 520, and overlapping a portion of object 310. Finally, as shown in FIG. 5C, a plate 503 is painted such that a portion of object 330 is is formed in knockout 520.

In conclusion, the present invention provides novel systems, methods and arrangements for exchanging data. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for trapping misregistration of a printing separation, the method comprising:
identifying a first color and a second color associated with a trap;
determining a first ink characteristic associated with the first color;
determining a second ink characteristic associated with the second color; and
determining a direction of the trap based at least in part on at least one of the first ink characteristic and the second ink characteristic.

2. The method of claim 1, wherein the direction of the trap is selected from a group consisting of:
a spread, a choke, a knockout, and an overprint.

3. The method of claim 1, wherein determining the first ink characteristic associated with the first color includes two or more operations selected from a group consisting of:
evaluating a total luminance for the first color based at least in part on the first ink;
evaluating a partial luminance for the first color based at least in part on the first ink;
evaluating a total gray for the first color based at least in part on the first ink;
evaluating a partial gray for the first color based at least in part on the first ink; and
evaluating a principle gray for the first color based at least in part on the first ink.

4. The method of claim 3, wherein determining the second ink characteristic associated with the first color includes two or more operations selected from a group consisting of:
evaluating a total luminance for the second color based at least in part on the second ink;
evaluating a partial luminance for the second color based at least in part on the second ink;
evaluating a total gray for the second color based at least in part on the second ink;
evaluating a partial gray for the second color based at least in part on the second ink; and
evaluating a principle gray for the second color based at least in part on the second ink.

5. The method of claim 1, wherein determining the first ink characteristic includes evaluating a partial gray value associated with the first ink, and wherein determining the direction of the trap includes:
comparing the partial gray value of the first ink with a partial gray value threshold, wherein the direction of the trap is a knockout where the partial gray value exceeds the partial gray threshold.

6. The method of claim 1, wherein the first color is a foreground color, and wherein the second color is a background color, wherein determining the first ink characteristic associated with the first color includes determining a luminance of the first color based at least in part on the first ink, wherein determining the second ink characteristic associated with the second color includes determining a luminance of the second color based at least in part on the second ink, and wherein determining the direction of the trap includes:
comparing the luminance of the first color with the luminance of the second color, wherein the direction of the trap is a spread where the luminance of the first color is greater than the luminance of the second color.

7. The method of claim 1, wherein the first color is a background color, and wherein the second color is a foreground color, wherein determining the first ink characteristic associated with the first color includes determining a luminance of the first color based at least in part on the first ink, wherein determining the second ink characteristic associated with the second color includes determining a luminance of the second color based at least in part on the second ink, and wherein determining the direction of the trap includes:
comparing the luminance of the first color with the luminance of the second color, wherein the direction of the trap is a choke where the luminance of the first color is greater than the luminance of the second color.

8. The method of claim 1, wherein the method further comprises:
determining a third ink characteristic associated with the first color, wherein determining the direction of the trap is based at least in part on the first ink characteristic, the second ink characteristic and the third ink characteristic.

9. The method of claim 8, wherein determining the first ink characteristic includes evaluating a partial gray value associated with the first ink, wherein determining the third ink characteristic includes evaluating a partial gray value associated with the third ink, and wherein determining the direction of the trap includes:
determining that the partial gray value of the first ink is less than a partial gray value threshold;
determining that the partial gray value of the third ink is greater than a rich black threshold; and
determining that the partial gray value of the first ink is less than the rich black threshold, wherein the direction of the trap is an overprint.

10. A method for correcting defects in a printing process, the method comprising:
identifying a first object, wherein the first object is a foreground object;
identifying a second object, wherein the second object is a background object;
creating a trap zone associated with the first object; and
determining a trap direction based at least in part on an ink characteristic of at least one of a color of the first object and a color of the second object.

11. The method of claim 10, wherein the method further includes:
determining a first ink characteristic associated with a color of the first object, wherein the first ink characteristic is a total luminance of the color of the first object;
determining a second ink characteristic associated with a color of the second object, wherein the second ink characteristic is a total luminance of the color of the second object; and
wherein determining a trap direction based at least in part on an ink characteristic of at least one of a color of the first object and a color of the second object includes comparing the total luminance of the color of the first object with the total luminance of the color of the second object.

12. The method of claim 11, wherein the total luminance of the color of the first object is greater than the total luminance of the color of the second object, and wherein the trap direction is determined to be a spread of the first object.

13. The method of claim 11, wherein the total luminance of the color of the first object is less than the total luminance of the color of the second object, and wherein the trap direction is determined to be a choke of the first object.

14. The method of claim 10, wherein the color of the first object is created using at least a first ink and a second ink, and wherein the method further includes:
determining a partial gray value of the first ink;
determining a partial gray value of the second ink; and
wherein determining a trap direction based at least in part on an ink characteristic of at least one of a color of the first object and a color of the second object includes:
determining that the partial gray value of the first ink is less than a partial gray value threshold;
determining that the partial gray value of the second ink is greater than a rich black threshold; and
determining that the partial gray value of the first ink is less than the rich black threshold, wherein the direction of the trap is an overprint of the first object.

15. The method of claim 10, wherein the method further includes:
determining the ink characteristic, wherein the ink characteristic is a partial gray value of the color of the first object;
wherein determining a trap direction based at least in part on an ink characteristic of at least one of a color of the first object and a color of the second object includes comparing the partial gray value includes comparing the partial gray value of the color of the first object with a partial gray threshold, wherein the partial gray value of the color of the first object is greater than the partial gray value threshold, and wherein the trap direction is determined to be a knockout of the first object.

16. A computer readable medium, the computer readable medium comprising:
instructions executable to identify a first object, wherein the first object is a foreground object;
instructions executable to identify a second object, wherein the second object is a background object;
instructions executable to create a trap zone associated with the first object; and
instructions executable to determine a trap direction based at least in part on an ink characteristic of at least one of a color of the first object and a color of the second object.

17. The computer readable medium of claim 16, wherein the computer readable medium further includes instructions executable to:
determine a first ink characteristic associated with a color of the first object, wherein the first ink characteristic is a total luminance of the color of the first object;
determine a second ink characteristic associated with a color of the second object, wherein the second ink characteristic is a total luminance of the color of the second object; and
wherein the instructions executable to determine a trap direction based at least in part on an ink characteristic of at least one of a color of the first object and a color of the second object include instructions executable to compare the total luminance of the color of the first object with the total luminance of the color of the second object.

18. The computer readable medium of claim 17, wherein the total luminance of the color of the first object is greater than the total luminance of the color of the second object, and wherein the trap direction is determined to be a spread of the first object.

19. The computer readable medium of claim 17, wherein the total luminance of the color of the first object is less than the total luminance of the color of the second object, and wherein the trap direction is determined to be a choke of the first object.

20. The computer readable medium of claim 16, wherein the color of the first object is created using at least a first ink and a second ink, wherein the computer readable medium further includes instructions executable to:
determine a partial gray value of the first ink;
determine a partial gray value of the second ink; and
wherein the instructions executable to determine a trap direction based at least in part on an ink characteristic of at least one of a color of the first object and a color of the second object include instructions executable to:
determine that the partial gray value of the first ink is less than a partial gray value threshold;
determine that the partial gray value of the second ink is greater than a rich black threshold; and
determine that the partial gray value of the first ink is less than the rich black threshold, wherein the direction of the trap is an overprint of the first object.

21. The computer readable medium of claim 16, wherein the computer readable medium further includes instructions executable to:
determine the ink characteristic, wherein the ink characteristic is a partial gray value of the color of the first object;
wherein the instructions executable to determine a trap direction based at least in part on an ink characteristic of at least one of a color of the first object and a color of the second object includes comparing the partial gray value include instructions executable to compare the partial gray value of the color of the first object with a partial gray threshold, wherein the partial gray value of the color of the first object is greater than the partial gray value threshold, and wherein the trap direction is determined to be a knockout of the first object.
